(19) United States
(12) Patent Application Publication
(10) Pub. No.: US 2022/0092535 A1
(43) Pub. Date: Mar. 24, 2022

(54) SHIPPING RESOURCE BASED REDIRECTION OF RETURN ITEMS

(71) Applicant: International Business Machines Corporation, Armonk, NY (US)

(72) Inventors: Zachary A. Silverstein, Jacksonville, FL (US); Lisa Seacat DeLuca, Baltimore, MD (US); Hemant Kumar Sivaswamy, Pune (IN); Juan C. Lopez, Tampa, FL (US)

(21) Appl. No.: 17/029,138

(22) Filed: Sep. 23, 2020

(51) Int. Cl. G06Q 10/08; G06Q 30/06

(52) U.S. Cl. CPC G06Q 10/0837; G06Q 30/0601; G06Q 10/08355; G06Q 10/08345

(57) ABSTRACT

Redirecting a return shipment to a buyer located along the predicted return route. Product returns are evaluated for redirection based on reason for return, purchaser qualification, and a buyer delivery location. Reduced relative shipping resources drives the redirecting action.

### BACKGROUND

The present invention relates generally to the field of e-commerce, and more particularly to product returns.

E-commerce (electronic commerce) is defined as the activity of electronically buying and/or selling of products and services online or over the internet. E-commerce is based on technologies such as electronic funds transfer, mobile commerce, supply chain management, internet marketing, online transaction processing, electronic data interchange (EDI), inventory management systems, and automated data collection systems. E-commerce is driven by the technological advances of the semiconductor industry, including home computer and handheld mobile devices, and to date, is a large sector of the current electronics industry. Modern e-commerce typically uses the world wide web for at least one part of the transaction life cycle, although it may also use other technologies such as e-mail.

### SUMMARY

According to an aspect of the present invention, there is a method, computer program product and/or system of providing peer to peer return based opportunity injection that performs the following operations (not necessarily in the following order): (i) identifying an item to be shipped from a purchaser location to a vendor location; (ii) determining the item is not defective; (iii) determining a shipping route for shipment of the item; (iv) identifying a set of users based on a delivery location for each user being within a specified distance from the shipping route; and (v) offering the item for sale to a first user of the set of users.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic portion of the first embodiment system; and

FIG. 4 is a system diagram showing a machine logic portion of the first embodiment system.

### DETAILED DESCRIPTION

Some embodiments of the present invention are directed to redirecting a return shipment to a buyer located along the predicted return route. Product returns are evaluated for redirection based on reason for return, purchaser qualification, and a buyer delivery location. Reduced relative shipping resources drives the redirecting action.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

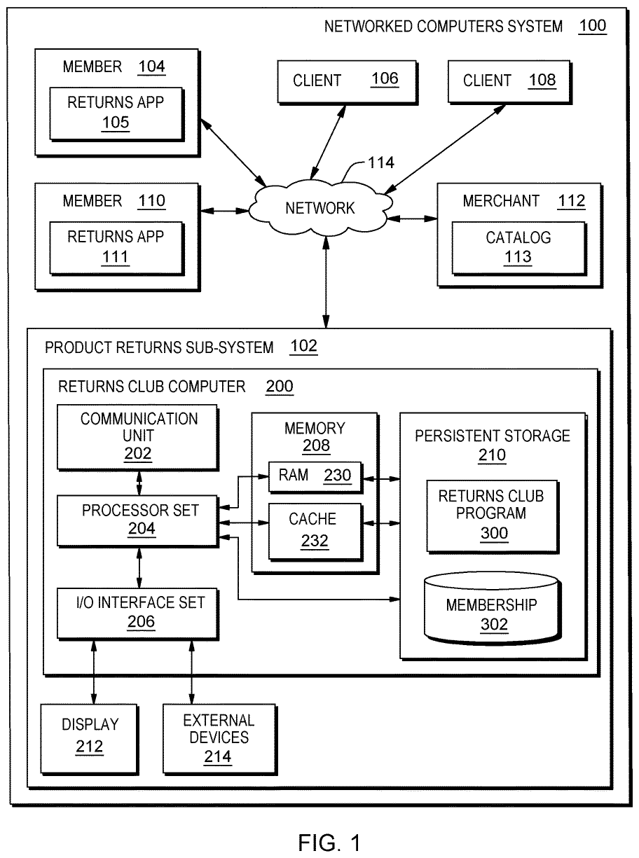

As shown in FIG. 1, networked computers system 100 is an embodiment of a hardware and software environment for use with various embodiments of the present invention. Networked computers system 100 includes: product returns subsystem 102 (sometimes herein referred to, more simply, as subsystem 102); member subsystems 104 and 110; returns applications 105 and 111; client sub-systems 106 and 108; merchant sub-system 112; web-based catalog 113; and communication network 114. Product returns subsystem 102 includes: returns club computer 200; communication unit 202; processor set 204; input/output (I/O) interface set 206; memory 208; persistent storage 210; display 212; external device(s) 214; random access memory (RAM) 230; cache 232; returns club program 300 (sometimes herein referred to, more simply, as program 300); and membership database 302.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with peer to peer computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

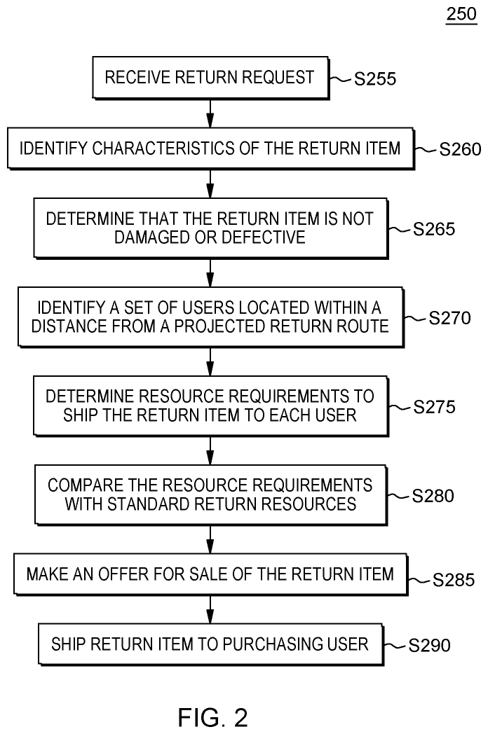

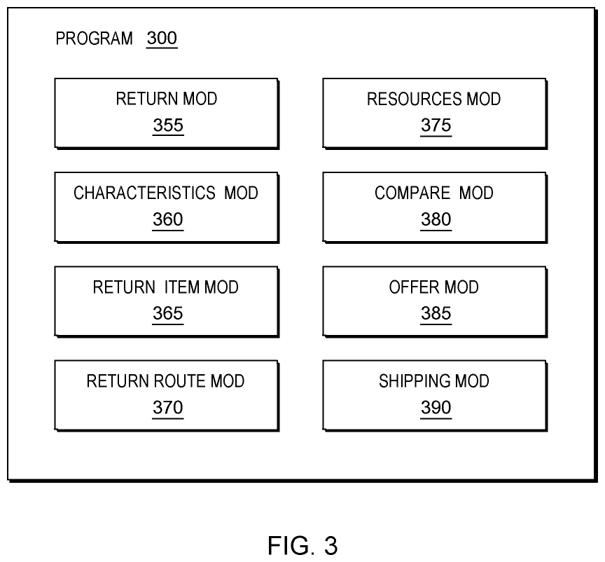

As shown in FIG. 1, networked computers system 100 is an environment in which an example method according to the present invention can be performed. As shown in FIG. 2, flowchart 250 shows an example method according to the present invention. As shown in FIG. 3, returns program 300 performs or controls performance of at least some of the method operations of flowchart 250. This method and associated software will now be discussed, over the course of the following paragraphs, with extensive reference to the blocks of FIGS. 1, 2, and 3.

Processing begins at operation S255, where return module (“mod”) 355 receives a return request for a return item. In this example, a participant in a returns club, member 104, has received a product from merchant 112 via catalog 113 (FIG. 1). The member wants to return the product to the merchant. The participant works through the returns club by submitting a return request via returns app 105. Alternatively, a merchant receives a return request and submits the request to the returns club for processing. According to some embodiments of the present invention, members join the returns club by providing information that may include: (i) initial purchases; (ii) secondary purchases; (iii) the couriers used for returns; (iv) participant name; and/or (v) shipping address.

Processing proceeds to operation S260, where characteristics mod 360 identifies characteristics of the return item. Characteristics may include: (i) product type; (ii) product name; (iii) serial/item number; (iv) merchant name; (v) color; (vi) features of product; (vii) quantity; and/or (viii) size. Characteristics may be determined in various ways including: (i) a user interface for selecting pre-defined descriptive characteristics; (ii) submission of photographs of the return product; (iii) a characteristics field or data entry form to be completed by the returning participant; and/or (iv) recording the characteristics by a representative of the merchant or returns club.

Processing proceeds to operation S265, where return item mod 365 determines that the return item is not damaged or otherwise defective. The return item mod determines an item status that may include physical condition and/or functionality of the return item. The item status may be determined in various ways including: (i) a user interface for selecting pre-defined status such as “defective,” “damaged,” “not my style,” and “not what I ordered;” (ii) a status field or data entry form to be completed by the returning participant; and/or (iv) contacting a representative of the merchant or returns club to enter the status. Various reasons that may be stated when determining whether or not a product is damaged or protected include: (i) unhappy with the look of the item; (ii) unhappy with the feel of the item; (iii) aesthetic scratches or damage; (iv) broken or damaged; (v) incompatibility issues; (vi) a slow shipping/fulfillment process by the e-commerce site; and/or (vii) transportation delays involving the courier. In this example, items that do not have an item status similar to “damaged” or “defective” are made available for other members, such as member 110, to order the return item via, for example, returns app 111 (FIG. 1). Alternatively, only specified item statuses are made available to other members. Alternatively, pre-defined item status terms are associated with a return action such that one status causes product to ship to a merchant location, another status causes the item to be shipped to a recycling or charitable location, and yet another pre-defined status causes the item to be placed on sale to other members.

Processing proceeds to operation S270, where return route mod 370 identifies a set of users located within a distance from a projected return route. In this example, the return route module accesses membership database 302 (FIG. 1) to identify the ship-from location of the return item and to identify the return shipping service to be used. Having this information, the return module is able to identify a projected shipping route for the return item. Alternatively, the ship-from location and shipping service are specified at step S255 with the return request. Alternatively, the ship-to location is determined according to the specified item status. For items to be placed on sale for other members, the ship-to location is estimated to be any of the users who are proximate to the return route to the merchant location. For a distance from the return route to be considered “proximate”, the distance will comply with a merchant or returns group policy and may vary according to value of the return item and/or resources required for shipping the return item to the merchant location. For example, an item having a high risk of damage during the return may not be permitted to be shipped to any location off the return route. Further, heavy return items that may require specialized resources to return the item may also be required to only consider shipping to users on the return route. Also, a return item that may ship by the selected return service to many global locations without additional cost will consider “proximate” to include locations nearby and a great distance away.

In this example, users who may purchase the return item are identified as “members” and are recorded to membership database 302. Alternatively, users are any persons who have provided public information of their location and/or have previously used or registered for purchase of return items. Return routes and determinations of distance to other users may be performed by a GPS system or other commercially available mapping program.

Processing proceeds to operation S275, where resources mod 375 determines resource requirements to ship the return item to each identified user. For each identified user, an evaluation of the resources required to ship the return item to them is performed. The analysis may include, but is not limited to: cost of shipping, shipping service availability, and/or purchase history of the identified user (that is, the identified user may often return the purchased products, thus increasing rather than decreasing resource requirements when a return item is purchased).

Processing proceeds to operation S280, where compare mod 380 compares the determined resource requirements for the set of users to purchase the return item with standard return resources for return to the merchant location. In this example, the objective is to reduce the use of return resources by identifying an alternative return location where a buyer is willing to purchase the return item. Alternatively, the objective is to use the same resources regardless of ship-to location by offering an appropriate sales discount or increase to users willing to purchase the return item. Alternatively, the objective is to reduce restocking return items by locating users to purchase return items so long as the returning user will offset the return resources to the extent that the exceed the standard return resources. The term “standard return resources” refers to costs, time, and resource availability for shipping the return item from the returning user location to a nearest available restocking location.

Processing proceeds to operation S285, where offer mod 385 makes an offer for sale of the return item. In this example, the set of users identified in step S270 are filtered according to the comparison of step S280 and a subset of users are identified as potential buyers including, for example, member 110 using returns app 111 (FIG. 1). The potential buyers are notified of the offer for sale of the return item. In this example, member 110 and other potential buyers are offered a price specific to the resource comparison performed in step S280 considering the particular objective of the merchant. Alternatively, a single price is determined based on highest price associated with the comparison process and that single price is presented to each user of the subset of users. Alternatively, during step S285, each user who qualifies for an offer for sale is sent an offer by offer mod 385 as the comparison is made instead of assembling a sub-set of qualified buyers and presenting the offer afterward.

Processing concludes at operation S290 where shipping mod 390 ships the return item to the potential buyer who accepted the offer for sale. In this example, member 110 accepts the offer via returns app 111 (FIG. 1). When a potential buyer accepts the offer for sale, the shipping module processes the shipment details in preparation to ship the return item to the accepting buyer. In some embodiments of the present invention, the shipping mod causes delivery of the return item directly to the accepting buyer. Further, the original courier who would have returned the shipment to the merchant may be used to perform the delivery to the accepting buyer or an alternate courier may be used.

### III. Further Comments and/or Embodiments

Some embodiments of the present invention recognize the following facts, potential problems and/or potential areas for improvement with respect to the current state of the art: (i) when purchasing an item from an e-commerce site, delivery is easily arranged, however, returning items can be time consuming and inefficient.

Some embodiments of the present invention are directed to a peer to peer return-based opportunity injection that addresses a returned item marked for pickup, contextualizes the trustworthiness of the reason for return, and provides a peer to peer and/or local transfer opportunity for ease of the burden of return shipping.

Some embodiments of the present invention may include one, or more, of the following operations, features, characteristics and/or advantages: (i) captures a returned item marked for pickup; (ii) contextualizes the trustworthiness of a user's return reasoning; (iii) provides a peer to peer/local transfer opportunity to assist the e-commerce site in shipping costs; (iv) enables selling to retail clients for return handling; (v) helps to connect retailers with couriers for same day delivery; and (vi) enhances further product differentiation for optimizing returns for retailers.

A method of implementation, according to an embodiment of the present invention, includes the following operations (not necessarily in the following order) where users opt into a peer to peer return process via an agreement with an e-commerce site/platform which includes: (i) data on: (a) initial purchases, (b) secondary purchasers, and (c) couriers information; (ii) first party who initially purchased item(s) on the e-commerce site/platform; (iii) a first party decision to return an item where return reasons may include but are not be limited to: (a) unhappiness with product look, (b) unhappiness with product feel, (c) light aesthetic damage or scratches, (d) broken or unusable damage, and/or (e) incompatibility; (iv) e-commerce portal retrieving including: (a) address of the first party, and (b) location where the first party is planning on returning an item including specific information such as: (1) shared parcel locker, (2) front door, and/or (3) returned to a storefront/third party; (v) e-commerce site/platform utilizing a predictive module to capture courier expected travel patterns with regards to picking up a given return, including return to a local warehouse, which is not mandatory; and (vi) e-commerce site/platform calculates users who are along the couriers route and creates a list of possible parties that: (a) can be absolute or can be relative, such as a radius, and (b) can be set to not perform a pickup, based on a trustworthiness score or return score of a user (for example, did the user accurately mark the damaged item and package for return).

A method of further implementation, according to an embodiment of the present invention, includes the following operations (not necessarily in the following order): (i) secondary users are matched with a predicted level of interest in the returned product, using known recommendation solutions, by capturing relevant data such as: (a) past purchase history, (b) current wish list items, (c) current cart items, and/or (d) browser history; (ii) if the secondary user is determined to be a potential match from operation (i) above, the secondary user, who is determined to be inside a courier's delivery route, is prompted with targeted marketing offers based on their location in relation to the pickup location, which includes, but are not limited to: (a) the delivery radius may allow for different discount thresholds (5 minute drive from path=40% reduced cost, 12 minute drive from path=10% reduced cost), and (b) the discount may be determined based on the reason for the return; (iii) there may be a higher discount if the item is being returned for damage than if the item is being returned for cosmetic reasons; (iv) along with direct messaging, the secondary user may also receive information such as: (a) reason for the return, and (b) photos of damage from the first user; (v) if a secondary user decides to purchase the item, the couriers' path on delivery day is manipulated, adding the peer to peer delivery to their path; and (vi) after the product is delivered, all parties benefit including: (a) there is no effect on the first user other than obtaining a refund, (b) the secondary user gets a product they accept at the price they want to pay, (c) couriers' route remains optimized, and (d) the e-commerce site/platform requires less logistics, warehouse space, lost goods, etc. based on product returns.

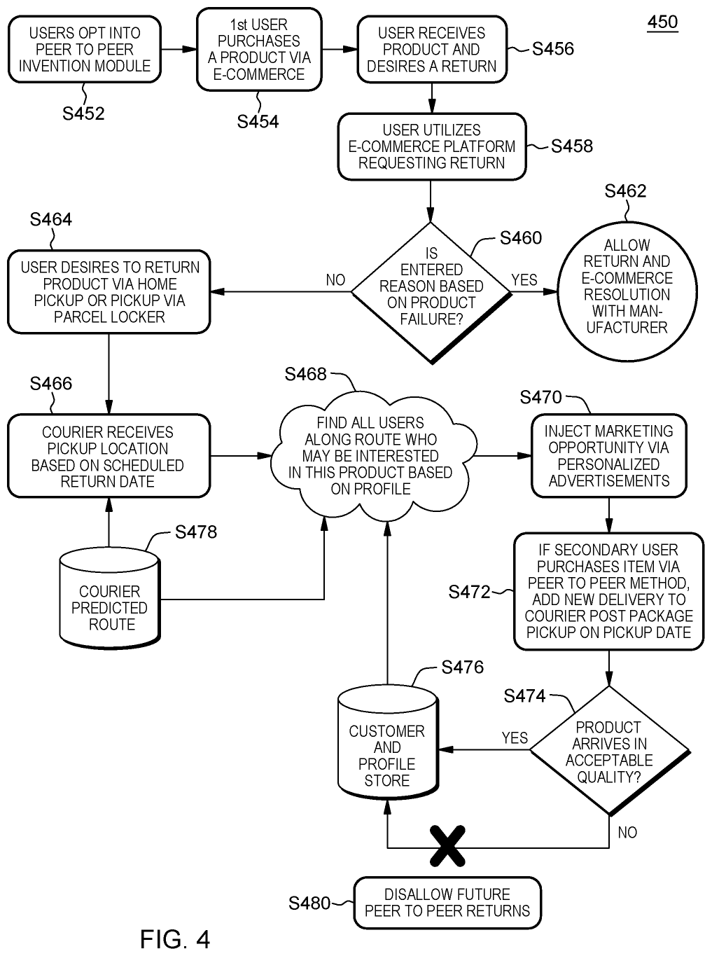

FIG. 4, described below, is a computing system for performing operations according to some embodiments of the present invention. The illustrated computing system may be designed to operate as part of a more comprehensive computing environment such as networked computers system 100 in FIG. 1.

Processing begins at operation S452, where users opts into a peer to peer return process. In this example, the users agree that if a return is requested, a peer to peer transaction may be performed if the user desires a return and the initially delivered product is not being returned due to a product failure.

Processing proceeds to operation S454, where a first user purchases a product via e-commerce. In this example, the order on the e-commerce platform can be placed by the user using a smartphone, tablet, laptop computer or other electronic communication device. The user includes their personal information as well as information on: (i) the initial purchase; (ii) secondary purchases; and/or (iii) the couriers used.

Processing proceeds to operation S456, where a user receives a product and desires to start a return. In this example, when the user decides to return an item, the reason for the return may include but is not limited to: (i) unhappy with the look of the product; (ii) unhappy with the feel of the product; (iii) aesthetic scratches or damage; (iv) broken or unusable damage; and/or (v) incompatibility.

Processing proceeds to operation S458, where a user utilizes the e-commerce platform to request a return. The e-commerce platform can be accessed by the user using a smartphone, tablet, laptop computer or other electronic communication device. The user will use the e-commerce return guidelines to begin the return request.

Processing proceeds to operation S460, where a determination is made if the requested return is based on a product failure. If the return request is based on a product failure “Yes”, processing continues to operation S462 below. If the return request in not based on a product failure “No”, the processing proceeds to operation S464 below.

Processing proceeds to operation S462, where the e-commerce site allows the return and resolution with the manufacturer. In this process, if the return is indeed based on a product failure, the e-commerce return process ends here.

If the process in operation S460 above is not based on a product failure, processing proceeds to operation S464 where the user desires to return a product via home pickup or pickup via a parcel locker. In this example, the e-commerce portal retrieves the location of the first party and the address where the first party is planning on returning the item. In addition, optional specific information may be used which includes but is not limited to: (i) a shared parcel locker; (ii) front door; and (iii) a store front/third party.

Processing proceeds to operation S466, where the courier receives a pickup location based on the scheduled return date. In this example, the e-commerce platform utilizes a predictive module to capture the couriers' expected travel pattern with regards to picking up a given return. Alternately, this could also include going to a local warehouse, but this option is not mandatory.

Processing proceeds to operation S468, where finding users along the route who may be interested in this product, based on the profile, is performed. In this example, the platform calculates users who are “along” the couriers route and creates a list of possible parties that: (i) can be absolute or can be relative, such as a radius; and (ii) can be set to not have a pickup, based on a trustworthiness score or return score of the user (for example, if the sender accurately mark the damaged package/item for return). Some embodiments of the present invention determine or predict a level of interest of the users when performing operation S468. Level of interest refers to a threshold interest such that the user is identified as a potential buyer. The threshold interest is determined in view of collected user preference data and historical purchasing activities among registered users.

Processing proceeds to operation S470, where marketing opportunities are injected via personalized advertisements. In this example, secondary users are matched with a predicted interest in the returned product, using known recommendation solutions and capturing relevance data such as: (i) past purchase history; (ii) current wish list items; (iii) current cart items; and/or (iv) browser history. In addition, if the secondary user is determined to be a potential match, the secondary users, inside the return pathway, are prompted with targeted marketing offers based on their location in relation to the pickup location where: (i) the radius may allow for different thresholds (e.g. 5 min drive from path=40% reduced cost and 12 min drive from path=10% reduced cost); and/or (ii) the discount may be determined based on the return reason (for example, a higher discount may be applied if the item is being returned for damage than if the item is being returned for cosmetic reasons).

Processing proceeds to operation S472, where if a secondary user purchases an item via the peer to peer process, a new delivery is added to the couriers' post package pickup on the pickup date. In this example, if a secondary user decides to purchase the item, the couriers' path on delivery day is manipulated, adding the peer to peer delivery time to their path.

Processing proceeds to operation S474, where the quality of the arrived product is determined. In this example, if the product quality is acceptable, processing continues to the “Yes” branch to operation S476 below. If the product quality is not acceptable, processing continues to the “No” branch to operation S480 below.

Processing proceeds to operation S476, where pertinent information about the customer and the customers profile is stored. The data from operation S474 above is stored in this storage, regardless if the product that arrived at the user was of acceptable quality or not.

Processing proceeds to operation S478, where courier predicated route storage data is provided to operation S466 and operation S468 above.

Processing concludes at operation S480, where if the product sent to a secondary user using the peer to peer process is not of acceptable quality, future peer to peer returns are disallowed.

A method according to an embodiment of the present invention includes the following operational example (not necessarily in the following order): (i) User A purchases a lamp from an online merchant that has a 30 day return window; (ii) User A decides that the lamp does not match well with his sofa and schedules a return pickup with the stated reasoning as “color does not match”; (iii) the e-commerce site/platform captures the request and records that a return item pickup is scheduled for the next day; (iv) User B lives within a pre-defined distance from the return route and the mailing address is already recorded in the e-commerce system; (v) the e-commerce site/platform determines User B may be interested in the item and offers the product at a reduced price to avoid costs of receiving a returned item; (vi) a mail courier picks up the package and sees that User A is a short distance away from User B's location; and (vii) all parties benefit where: (a) User A does not have a negative record for the return, (b) the e-commerce site does not process the returning and the re-shipping of the product, (c) the mail courier is able to remain within a pre-defined distance from a standard return route, and (d) User B gets the product at a reduced price.

Some embodiments of the present invention recognize the following facts, potential problems and/or potential areas for improvement with respect to the current state of the art: (i) the return can be integrated into a personal or enterprise drone-based system for reduced delivery times; (ii) the return can utilize the social scoring factor or use reviews or customer feedback scoring to determine a risk of processing the return via a local peer to peer transaction; (iii) the social scoring factor and/or user reviews have an impact on resale or peer to peer return price; and (iv) an incentivization module can be used for proper return notation, whereupon a user receives credit on future e-commerce purchases.

Some embodiments of the present invention recognize a method of providing peer to peer return based opportunity injection, the method comprising: (i) capturing information regarding an item that is marked for return; (ii) contextualizing the accuracy of the reason for returning an item; and (iii) providing a peer to peer transfer opportunity for the item, by predicting reduced return shipping costs for a given e-commerce site.

Some embodiments of the present invention may include one, or more, of the following operations, features, characteristics and/or advantages: (i) uses data to orchestrate peer to peer exchanges; (ii) centers around a peer to peer exchange based on attributes; (iii) provides for consumer data collection and the method used to relay potential opportunities for consumers; (iv) takes into account an offering based on the effect it would have on the courier instead of a flat radius around the “returning” user; (v) considers the impact to the courier including current capacity, expected time left in the work shift, delivery schedule, etc.; (vi) disallows a user to participate in the return if trust in a given user falls below a given threshold; (vii) specifically captures non-consumables or products that are in a returnable condition; and (viii) determines a peer to peer based return by specified courier: (a) predicted return route, (b) route changes; (c), capacity; and/or (d) timing.

Some embodiments of the present invention may include one, or more, of the following operations, features, characteristics and/or advantages: (i) ensures that using a peer to peer delivery process logistically makes sense for the courier to pick up the given product; (ii) ensures the product delivery matches the couriers predicted path; (iii) if a peer to peer delivery is initiated, ensures the parties engaged in the delivery are trusted to execute the transaction; and/or (iv) ensures the courier has the necessary capacity to facilitate a peer to peer transaction based on the weight, size, etc. of the item(s).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method comprising:
creating a secondary purchaser data set including information indicative of: (i) identities of a plurality of secondary purchasers, with each secondary purchaser being a retailer that is interested in buying returned goods, (ii) location information for each secondary purchaser of the plurality of secondary purchasers, and (iii) contact information for each secondary purchaser of the plurality of secondary purchasers;
identifying an item to be that a primary purchaser has purchased, received and requested to return to a primary vendor;
determining a first secondary purchaser in the same local area as the primary purchaser based on the secondary purchaser data set;
offering the first secondary purchaser an offer to purchase the item from the primary vendor;
receiving, from the first secondary purchaser, acceptance of the offer to purchase the item from the primary purchaser; and
responsive to the receipt of the acceptance, instructing the primary purchaser to return the item to the first secondary purchaser in the same local area as the primary purchaser.

2. The computer-implemented method of claim 1 wherein the primary purchaser has stated that a reason for return of the item is one of the following reasons: unhappiness with product look, unhappiness with product feel, or light aesthetic damage or scratches.

3-20. (canceled)
